(19) United States
(12) Patent Application Publication
(10) Pub. No.: US 2025/0322776 A1
(43) Pub. Date: Oct. 16, 2025

(54) LIGHT-EMITTING DEVICE, DISPLAY APPARATUS, AND METHOD FOR INSPECTING LIGHT-EMITTING DEVICE

(71) Applicant: Sharp Display Technology Corporation, Kameyama City (JP)

(72) Inventor: Kazuya Nakaminami, Kameyama City (JP)

(21) Appl. No.: 19/097,108

(22) Filed: Apr. 1, 2025

(30) Foreign Application Priority Data
Apr. 10, 2024 (JP) 2024-063369

(51) Int. Cl. G09G 3/00; G09G 3/34

(52) U.S. Cl. CPC G09G 3/006; G09G 3/3426; G09G 2320/045; G09G 2330/12

(57) ABSTRACT

A light-emitting device includes a plurality of light-emitting units each constituted by a plurality of light-emitting elements connected in series and in a forward direction. The plurality of light-emitting units include a first light-emitting unit and a second light-emitting unit corresponding to the first light-emitting unit. A first anode side node serving as an anode side node of the first light-emitting unit is connected to a second anode side node serving as an anode side node of the second light-emitting unit. A first cathode side node serving as a cathode side node of the first light-emitting unit is connected to a second cathode side node serving as a cathode side node of the second light-emitting unit. The light-emitting device further includes a switch located between the first cathode side node and the second anode side node.

### BACKGROUND

### 1. Field

The present disclosure relates to a light-emitting device having a plurality of light-emitting elements.

### 2. Description of the Related Art

Various technologies have been proposed for light-emitting devices having light-emitting elements such as LEDS (light-emitting diodes) as light sources. For example, Japanese Unexamined Patent Application Publication No. 2012-99629 discloses a technology intended to detect a misconnection of a cable connecting an LED substrate and an LED driving substrate to each other in an LED lighting device.

It is desirable to detect, with a method that is different from a conventional method, an abnormality in a light-emitting device having a plurality of light-emitting elements.

### SUMMARY

According to an aspect of the disclosure, there is provided a light-emitting device including a plurality of light-emitting units each constituted by a plurality of light-emitting elements connected in series and in a forward direction. The plurality of light-emitting units include a first light-emitting unit and a second light-emitting unit corresponding to the first light-emitting unit. A first anode side node serving as an anode side node of the first light-emitting unit is connected to a second anode side node serving as an anode side node of the second light-emitting unit. A first cathode side node serving as a cathode side node of the first light-emitting unit is connected to a second cathode side node serving as a cathode side node of the second light-emitting unit. The light-emitting device further includes a switch located between the first cathode side node and the second anode side node.

According to an aspect of the disclosure, there is provided a method for inspecting a light-emitting device. The light-emitting device includes a plurality of light-emitting units each constituted by a plurality of light-emitting elements connected in series and in a forward direction. The plurality of light-emitting units include a first light-emitting unit and a second light-emitting unit corresponding to the first light-emitting unit. A first anode side node serving as an anode side node of the first light-emitting unit is connected to a second anode side node serving as an anode side node of the second light-emitting unit. A first cathode side node serving as a cathode side node of the first light-emitting unit is connected to a second cathode side node serving as a cathode side node of the second light-emitting unit. The light-emitting device further includes a switch located between the first cathode side node and the second anode side node. The method includes connecting the first cathode side node and the second anode side node to each other by turn on the switch in starting an inspection mode of inspecting the light-emitting device for an abnormality in the first light-emitting unit and the second light-emitting unit.

### BRIEF DESCRIPTION OF THE DRAWINGS

FIG. 1 shows an example configuration of a display apparatus according to Reference Embodiment;

FIG. 2 shows examples of signals that are outputted from a plurality of signal terminals according to Reference Embodiment;

FIG. 3 shows another example configuration of a display apparatus according to Reference Embodiment;

FIG. 4 shows an example configuration of a display apparatus according to Embodiment 1;

FIG. 5 shows examples of signals that are outputted from a plurality of signal terminals according to Embodiment 1;

FIG. 6 is a diagram for explaining a first example of operation of the display apparatus according to Embodiment 1; and

FIG. 7 is a diagram for explaining a second example of operation of the display apparatus according to Embodiment 1.

### DESCRIPTION OF THE EMBODIMENTS

### Reference Embodiment

Prior to a description of a display apparatus 1P according to Embodiment 1, Reference Embodiment is described. For convenience of explanation, constituent elements (components) having the same functions as those of constituent elements described in Reference Embodiment are given the same reference signs in each of the subsequent embodiments, and a description of such constituent elements is not repeated. Further, for brevity, a description of matters that are similar to publicly-known technologies is omitted as appropriate.

Each component and each numerical value described herein are for illustrative purposes only unless a particular contradiction arises. Therefore, for example, the numbers of components, positional relationships between components, relations of connection between components, or other features are not limited to any of the examples shown in the drawings unless a particular contradiction arises. The phrase “being connected” herein means “being electrically connected” unless otherwise defined.

### Example Configuration of Display Apparatus According to Reference Embodiment

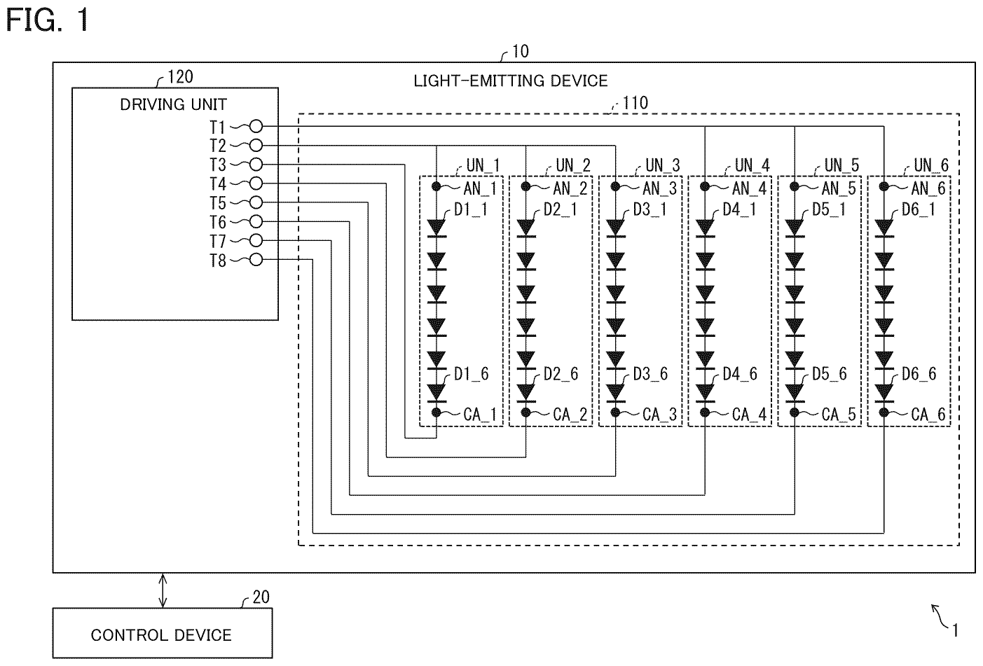

FIG. 1 shows an example configuration of a display apparatus according to Reference Embodiment. The display apparatus of FIG. 1 is referred to as a “display apparatus 1”.

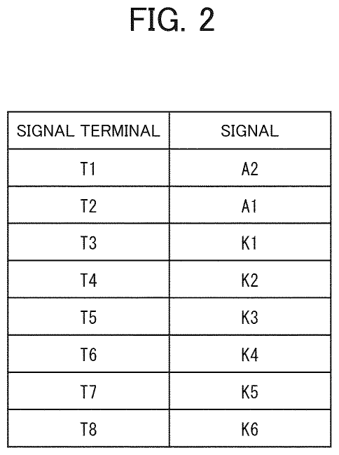

FIG. 2 shows examples of signals that are outputted from a plurality of signal terminals (described later) of the display apparatus 1.

First, FIG. 1 is referred to. The display apparatus 1 includes a light-emitting device 10 and a control device 20. The light-emitting device 10 has a plurality of light-emitting elements. A case where the light-emitting elements are LEDs is illustrated herein.

The control device 20 controls all parts of the display apparatus 1. A case where the control device 20 controls the light-emitting device 10 is described herein. Note, however, that the control device 20 may control an unillustrated component of the display apparatus 1. For example, in a case where the display apparatus 1 is a liquid crystal display apparatus, the display apparatus 1 has a liquid crystal panel. In this case, the control device 20 may control the liquid crystal panel.

A case where the display apparatus 1 is a liquid crystal display apparatus is discussed as an example. In this case, for example, the light-emitting device 10 is a backlight of the display apparatus 1. The light-emitting elements of the light-emitting device 10 are, for example, white LEDs that emit white light. In the display apparatus 1, white light serving as illuminating light is emitted from the light-emitting device 10 toward the liquid crystal panel. Accordingly, the luminance of the emitted light can be controlled by controlling the light-emitting device 10 with the control device 20.

In the example shown in FIG. 1, the light-emitting device 10 includes six light-emitting units UN_1 to UN_6 mounted on a circuit substrate 110. A plurality of light-emitting units (e.g. the six light-emitting units UN_1 to UN_6) may be herein collectively denoted as “light-emitting units UN”.

In the example shown in FIG. 1, the plurality of light-emitting units UN are connected in parallel to one another. Moreover, each one of the light-emitting units UN is constituted by a plurality of light-emitting elements connected in series and in a forward direction. In the example shown in FIG. 1, each one of the light-emitting units UN is constituted by six light-emitting elements.

Of the plurality of light-emitting units UN, the ith light-emitting unit is herein denoted as a “light-emitting unit U_i”. i is any natural number that satisfies 1≤i≤N. N is the total number of light-emitting units UN of the light-emitting device 10. In the example shown in FIG. 1, N=6.

Light-emitting elements belonging to the light-emitting unit UN_i are herein collectively denoted as “light-emitting elements Di”. Moreover, of the plurality of light-emitting elements Di belonging to the light-emitting unit UN_i, the jth light-emitting element is denoted as a “light-emitting element Di_j”. M is the number of light-emitting elements belonging to one light-emitting unit UN of the light-emitting device 10. In the example shown in FIG. 1, M=6. Accordingly, in the example shown in FIG. 1, the light-emitting device 10 has 36 light-emitting elements in total.

In the example shown in FIG. 1, the light-emitting device 10 includes a driving unit 120 that drives each of the plurality of light-emitting units UN. For a given i, an anode of a light-emitting element Di_1 belonging to the light-emitting unit UN_i is herein connected to a signal terminal of the driving unit 120, and a cathode of a light-emitting element Di_M belonging to the light-emitting unit UN_i is herein connected to another signal terminal of the driving unit 120.

In addition, as is clear from the foregoing description, for a given i in the range 1≤j≤M−1 in the light-emitting unit UN_i, a cathode of the light-emitting element Di_j is connected to an anode of a light-emitting element Di_(j+1).

Accordingly, the light-emitting unit UN_i has an anode side node AN_i and a cathode side node CA_i. The anode side node AN_i herein means, of nodes in the light-emitting unit UN_i, a node that is at the same potential as the anode of the light-emitting element Di_1. Further, the cathode side node CA_i means, of the nodes in the light-emitting unit UN_i, a node that is at the same potential as the cathode of the light-emitting element Di_M.

The driving unit 120 drives each of the plurality of light-emitting units UN upon instruction from the control device 20. Signals that are supplied from the driving unit 120 to anode side nodes are herein collectively denoted as “anode signals”. The anode signals A1 and A2 shown in FIG. 2 are individual anode signals. Further, signals that are supplied from the driving unit 120 to cathode side nodes are collectively denoted as “cathode signals”. The cathode signals K1 to K6 shown in FIG. 2 are individual cathode signals.

In the example shown in FIG. 1, the driving unit 120 has eight signal terminals T1 to T8. The signal terminal T1 is connected to anode side nodes AN_4 to AN_6. This makes it possible to supply the anode signal A2 from the driving unit 120 to each of the light-emitting units UN_4 to UN_6 through the signal terminal T1.

The signal terminal T2 is connected to anode side nodes AN_1 to AN_3. This makes it possible to supply the anode signal A1 from the driving unit 120 to each of the light-emitting units UN_1 to UN_3 through the signal terminal T2.

As noted above, in the example shown in FIG. 1, one signal terminal of the driving unit 120 is connected to a plurality of anode side nodes. Specifically, in the example shown in FIG. 1, one signal terminal of the driving unit 120 is connected to three anode side nodes.

On the other hand, in the example shown in FIG. 1, one signal terminal of the driving unit 120 is connected to one cathode side node. For example, the signal terminal T3 is connected to a cathode side node CA_1. This makes it possible to supply the cathode signal K1 from the driving unit 120 to the light-emitting unit UN_1 through the signal terminal T3.

Similarly, the signal terminal T4 is connected to a cathode side node CA_2, the signal terminal T5 to a cathode side node CA_3, the signal terminal T6 to a cathode side node CA_4, the signal terminal T7 to a cathode side node CA_5, and the signal terminal T8 to a cathode side node CA_6.

This makes it possible to supply the cathode signal K2 to the light-emitting unit UN_2 through the signal terminal T4, supply the cathode signal K3 to the light-emitting unit UN_3 through the signal terminal T5, supply the cathode signal K4 to the light-emitting unit UN_4 through the signal terminal T6, supply the cathode signal K5 to the light-emitting unit UN_5 through the signal terminal T7, and supply the cathode signal K6 to the light-emitting unit UN_6 through the signal terminal T8.

Incidentally, in a case where there is an abnormality (e.g. deterioration) in a light-emitting element constituting a light-emitting unit UN, e.g. in a case where the light-emitting element is driven at a low current, the light-emitting element may fail to emit light properly (or, for example, may not emit light at all). For this reason, in a case where there is an abnormality in a light-emitting element constituting a light-emitting unit UN, there may be a reduction in display quality of the display apparatus 1.

Even if all light-emitting elements are confirmed normal at the time of manufacture of the light-emitting device 10, there may occur an abnormality in any of the light-emitting elements after the light-emitting device 10 has been incorporated into the display apparatus 1. For this reason, it is desirable to detect an abnormality in a light-emitting unit UN of the light-emitting device 10 without removing the light-emitting device 10 from the display apparatus 1.

To this end, the display apparatus 1 is configured such that the light-emitting device 10 can be operated in a mode (hereinafter referred to as an “inspection mode”) of inspecting the light-emitting device 10 for an abnormality in a light-emitting unit UN of the light-emitting device 10. For example, the control device 20 starts the inspection mode of the light-emitting device 10 upon accepting a predetermined input operation from a user of the display apparatus 1.

In the example shown in FIG. 1, in the inspection mode of the light-emitting device 10, the control device 20 controls the driving unit 120 to supply an anode signal of a predetermined signal value and a cathode signal of a predetermined signal value to one light-emitting unit UN. As a result of that, an inspecting current flows through the light-emitting unit UN. It is assumed herein that a current value of the inspection current is set smaller than a current value of an electric current that is passed through the light-emitting unit UN in a normal display mode of the display apparatus 1.

As one example, a case where the light-emitting unit UN_1 is inspected is described. In this case, the anode signal A1 of a predetermined signal value is supplied to the anode side node AN_1 through the signal terminal T2, and the cathode signal K1 of a predetermined signal value is supplied to the cathode side node CA_1 through the signal terminal T3. As a result of that, the inspection current flows through the light-emitting unit UN_1.

This causes a forward voltage Vf_1 corresponding to the inspection current to be generated in the light-emitting unit UN_1. The forward voltage Vf_1 in the light-emitting unit UN_1 is equal to the sum of forward voltages of light-emitting elements D1_1 to D1_6. In a case where there is an abnormality in any of the light-emitting elements D1_1 to D1_6, Vf_1 may become lower than it is in a case where all of the light-emitting elements D1_1 to D1_6 are sound. This makes it possible to, in the inspection mode of the light-emitting device 10, determine, on the basis of Vf_1 in the light-emitting unit UN_1, whether there is an abnormality in the light-emitting unit UN_1.

To this end, the light-emitting device 10 may have a voltage sensor (not illustrated) that measures a potential difference between two signal terminals of the driving unit 120 that correspond to a certain light-emitting unit UN. As one example, a case where a voltage sensor that detects a potential difference between the signal terminal T2 and the signal terminal T3, which correspond to the light-emitting unit UN_1, is provided is discussed. In this case, the control device 20 acquires, as Vf_1 in the inspection mode, a detected value of the potential difference detected by the voltage sensor in the inspection mode. Then, the control device 20 determines, on the basis of Vf_1, whether there is an abnormality in the light-emitting unit UN_1.

### Another Example Configuration of Display Apparatus According to Reference Embodiment

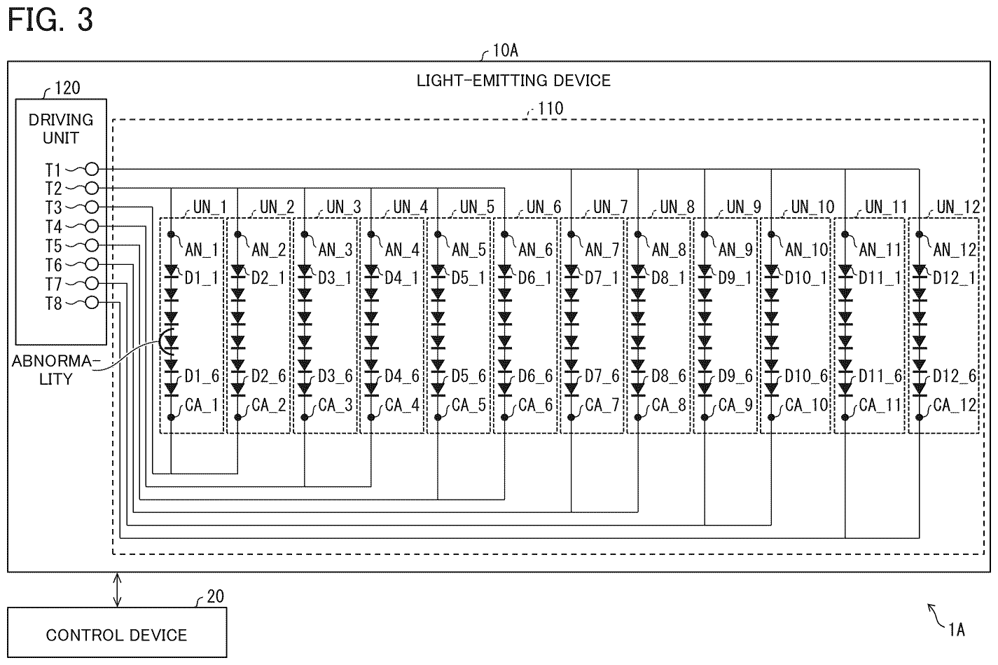

FIG. 3 shows another example configuration of a display apparatus according to Reference Embodiment. The display apparatus of FIG. 3 is referred to as a “display apparatus 1A”. Also in the display apparatus 1A, signals are outputted from the signal terminals T1 to T8 as mentioned in FIG. 2 above.

The display apparatus 1A has a light-emitting device 10A in place of the light-emitting device 10. FIG. 3 illustrates a case where N=12 unlike in the example shown in FIG. 1. Accordingly, in FIG. 3, the light-emitting device 10A has 72 light-emitting elements in total.

In the example shown in FIG. 3, the light-emitting device 10A includes twelve light-emitting units UN_1 to UN_12. Accordingly, FIG. 3 shows twelve anode side nodes AN_1 to AN_12 and twelve cathode side nodes CA_1 to CA_12.

Thus, the value of N in the example shown in FIG. 3 is twice as large as the value of N in the example shown in FIG. 1. Meanwhile, the driving unit 120 in the example shown in FIG. 3 is equal to that in the example shown in FIG. 1. For this reason, a relation of connection between the driving unit 120 and each of the plurality of light-emitting units UN in the example shown in FIG. 3 is different from that in the example shown in FIG. 1.

Specifically, in the example shown in FIG. 3, one signal terminal of the driving unit 120 is connected to six anode side nodes. In the example shown in FIG. 3, the signal terminal T1 is connected to each of the anode side nodes AN_7 to AN_12. Moreover, the signal terminal T2 is connected to each of the anode side nodes AN_1 to AN_6.

Accordingly, in the example shown in FIG. 3, in a case where the anode signal A2 is outputted from the signal terminal T1, the anode signal A2 is supplied to each of the light-emitting units UN_7 to UN_12. In a case where the anode signal A1 is outputted from the signal terminal T2, the anode signal A1 is supplied to each of the light-emitting units UN_1 to UN_6.

In addition, in the example shown in FIG. 3, one signal terminal of the driving unit 120 is connected to two cathode side nodes. In the example shown in FIG. 3, the signal terminal T3 is connected to the cathode side nodes CA_1 and CA_2. Accordingly, in the example shown in FIG. 3, the cathode side node CA_1 is connected to the cathode side node CA_2 unlike in the example shown in FIG. 1. For this reason, in the example shown in FIG. 3, in a case where the cathode signal K1 is outputted from the signal terminal T3, the cathode signal K1 is supplied to each of the light-emitting units UN_1 and UN_2.

The signal terminal T4 is connected to the cathode side nodes CA_3 and CA_4. Accordingly, in the example shown in FIG. 3, the cathode side node CA_3 is connected to the cathode side node CA_4 unlike in the example shown in FIG. 1. In the example shown in FIG. 3, in a case where the cathode signal K2 is outputted from the signal terminal T4, the cathode signal K2 is supplied to each of the light-emitting units UN_3 and UN_4.

The signal terminal T5 is connected to the cathode side nodes CA_5 and CA_6. Accordingly, in the example shown in FIG. 3, the cathode side node CA_5 is connected to the cathode side node CA_6 unlike in the example shown in FIG. 1. In the example shown in FIG. 3, in a case where the cathode signal K3 is outputted from the signal terminal T5, the cathode signal K3 is supplied to each of the light-emitting units UN_5 and UN_6.

The signal terminal T6 is connected to the cathode side nodes CA_7 and CA_8. Accordingly, the cathode side node CA_7 is connected to the cathode side node CA_8. In the example shown in FIG. 3, in a case where the cathode signal K4 is outputted from the signal terminal T7, the cathode signal K4 is supplied to each of the light-emitting units UN_7 and UN_8.

The signal terminal T7 is connected to the cathode side nodes CA_9 and CA_10. Accordingly, the cathode side node CA_9 is connected to the cathode side node CA_10. In the example shown in FIG. 3, in a case where the cathode signal K5 is outputted from the signal terminal T7, the cathode signal K5 is supplied to each of the light-emitting units UN_9 and UN_10.

The signal terminal T8 is connected to the cathode side nodes CA_11 and CA_12. Accordingly, the cathode side node CA_11 is connected to the cathode side node CA_12. In the example shown in FIG. 3, in a case where the cathode signal K6 is outputted from the signal terminal T8, the cathode signal K6 is supplied to each of the light-emitting units UN_11 and UN_12.

As one example, a case where, in the inspection mode of the light-emitting device 10A, the anode signal A1 is outputted from the signal terminal T2 and the cathode signal K1 is outputted from the signal terminal T3 is discussed. In the configuration of FIG. 3, the anode signal A1 and the cathode signal K1 are supplied to both the light-emitting unit UN_1 and the light-emitting unit UN_2. That is, in the configuration of FIG. 3, unlike in the configuration of FIG. 1, it is not possible to drive only either the light-emitting unit UN_1 or the light-emitting unit UN_2.

In the configuration of FIG. 3, for example, even in a case where there is an abnormality in one light-emitting element in the light-emitting unit UN_1 and all light-emitting elements in the light-emitting unit UN_2 are sound, a potential difference between the signal terminal T1 and the signal terminal T3 is equal. Therefore, it is not possible with the configuration of FIG. 3 to appropriately determine, on the basis of the potential difference, whether there is an abnormality in each of the light-emitting units UN_1 and UN_2. For example, it is not possible with the configuration of FIG. 3 to detect that there is an abnormality in the light-emitting unit UN_1 alone.

### Embodiment 1

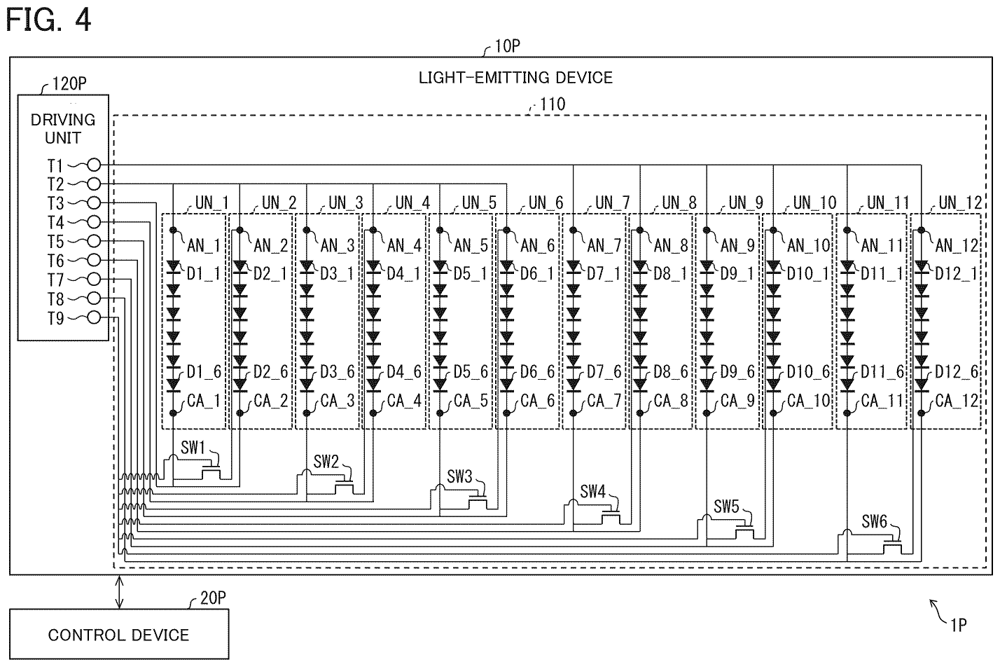

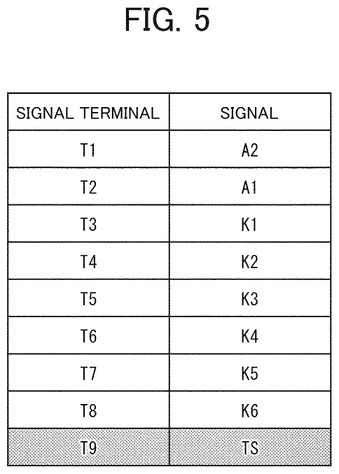

The inventor of the present application created a novel display apparatus (particularly a novel light-emitting device) to cope with the aforementioned problems that arise in the example configuration of FIG. 3 according to Reference Embodiment. Embodiment 1 illustrates the novel display apparatus. FIG. 4 shows an example configuration of a display apparatus according to Embodiment 1. The display apparatus of FIG. 4 is referred to as a “display apparatus 1P”. FIG. 4 is a diagram that is paired up with FIG. 3. FIG. 5 shows examples of signals that are outputted from a plurality of signal terminals of the display apparatus 1P. FIG. 5 is a diagram that is paired up with FIG. 2.

The display apparatus 1P includes a light-emitting device 10P and a control device 20P. As with the light-emitting device 10A, the light-emitting device 10P has twelve light-emitting units UN_1 to UN_12. Meanwhile, unlike the light-emitting device 10A, the light-emitting device 10P has six switches SW1 to SW6.

The six switches SW1 to SW6 are herein sometimes collectively referred to as “switches SW”. In the example of Embodiment 1, it is assumed that all switches SW are in an off (open) state in a case where the light-emitting device 10P is not operating in the inspection mode. The switches SW may be semiconductor switches of any type. In the example shown in FIG. 4, the switches SW are pMOS (positive metal oxide semiconductor) transistors.

In the example shown in FIG. 4, the switch SW1 is a switch that corresponds to the light-emitting unit UN_1 and the light-emitting unit UN_2. The switch SW1 is located between the cathode side node CA_1 and the anode side node AN_2. Accordingly, prior to the start of the inspection mode, the cathode side node CA_1 and the anode side node AN_2 are electrically isolated from each other by the switch SW1.

The switch SW2 is a switch that corresponds to the light-emitting unit UN_3 and the light-emitting unit UN_4. The switch SW2 is located between the cathode side node CA_3 and the anode side node AN_4. Accordingly, prior to the start of the inspection mode, the cathode side node CA_3 and the anode side node AN_4 are electrically isolated from each other by the switch SW2.

The switch SW3 is a switch that corresponds to the light-emitting unit UN_5 and the light-emitting unit UN_6. The switch SW3 is located between the cathode side node CA_5 and the anode side node AN_6. Accordingly, prior to the start of the inspection mode, the cathode side node CA_5 and the anode side node AN_6 are electrically isolated from each other by the switch SW3.

The switch SW4 is a switch that corresponds to the light-emitting unit UN_7 and the light-emitting unit UN_8. The switch SW4 is located between the cathode side node CA_7 and the anode side node AN_8. Accordingly, prior to the start of the inspection mode, the cathode side node CA_7 and the anode side node AN_8 are electrically isolated from each other by the switch SW4.

The switch SW5 is a switch that corresponds to the light-emitting unit UN_9 and the light-emitting unit UN_10. The switch SW5 is located between the cathode side node CA_9 and the anode side node AN_10. Accordingly, prior to the start of the inspection mode, the cathode side node CA_9 and the anode side node AN_10 are electrically isolated from each other by the switch SW5.

The switch SW6 is a switch that corresponds to the light-emitting unit UN_11 and the light-emitting unit UN_12. The switch SW6 is located between the cathode side node CA_11 and the anode side node AN_12. Accordingly, prior to the start of the inspection mode, the cathode side node CA_11 and the anode side node AN_12 are electrically isolated from each other by the switch SW6.

As noted above, in Embodiment 1, one switch SW corresponds to two light-emitting units UN. For this reason, in a case where the aforementioned N is an even number, the light-emitting device 10P needs only have N/2 switches.

The driving unit of the light-emitting device 10P is referred to as a “driving unit 120P”. Unlike the driving unit 120, the driving unit 120P further has a signal terminal T9. In the example shown in FIG. 4, the signal terminal T9 is connected to each of the switches SW1 to SW6.

The driving unit 120P outputs a switching control signal TS (see FIG. 5) through the signal terminal T9 upon instruction from the control device 20P. Thus, in the display apparatus 1P, the switching control signal TS is supplied to each of the switches SW1 to SW6 through the signal terminal T9.

In starting the inspection mode of the light-emitting device 10P, the control device 20P causes the driving unit 120P to output the switching control signal TS (e.g. a High value of TS) as a turn-on signal. This causes the switches SW1 to SW6 to be turned on.

Accordingly, in the inspection mode, (i) the turning on of the switch SW1 causes the cathode side node CA_1 and the anode side node AN_2 to become connected to each other, (ii) the turning on of the switch SW2 causes the cathode side node CA_3 and the anode side node AN_4 to become connected to each other, (iii) the turning on of the switch SW3 causes the cathode side node CA_5 and the anode side node AN_6 to become connected to each other, (iv) the turning on of the switch SW4 causes the cathode side node CA_7 and the anode side node AN_8 to become connected to each other, (v) the turning on of the switch SW5 causes the cathode side node CA_9 and the anode side node AN_10 to become connected to each other, and (vi) the turning on of the switch SW6 causes the cathode side node CA_11 and the anode side node AN_12 to become connected to each other.

In ending the inspection mode, the control device 20P causes the driving unit 120P to output the switching control signal TS (e.g. a Low value of TS) as a turn-off signal. This causes the switches SW1 to SW6 to be turned off.

Accordingly, at the end of the inspection mode, (i) the turning off of the switch SW1 causes the cathode side node CA_1 and the anode side node AN_2 to become electrically isolated from each other, (ii) the turning off of the switch SW2 causes the cathode side node CA_3 and the anode side node AN_4 to become electrically isolated from each other, (iii) the turning off of the switch SW3 causes the cathode side node CA_5 and the anode side node AN_6 to become electrically isolated from each other, (iv) the turning off of the switch SW4 causes the cathode side node CA_7 and the anode side node AN_8 to become electrically isolated from each other, (v) the turning off of the switch SW5 causes the cathode side node CA_9 and the anode side node AN_10 to become electrically isolated from each other, and (vi) the turning off of the switch SW6 causes the cathode side node CA_11 and the anode side node AN 12 to become electrically isolated from each other.

### First Example of Operation of Display Apparatus 1P

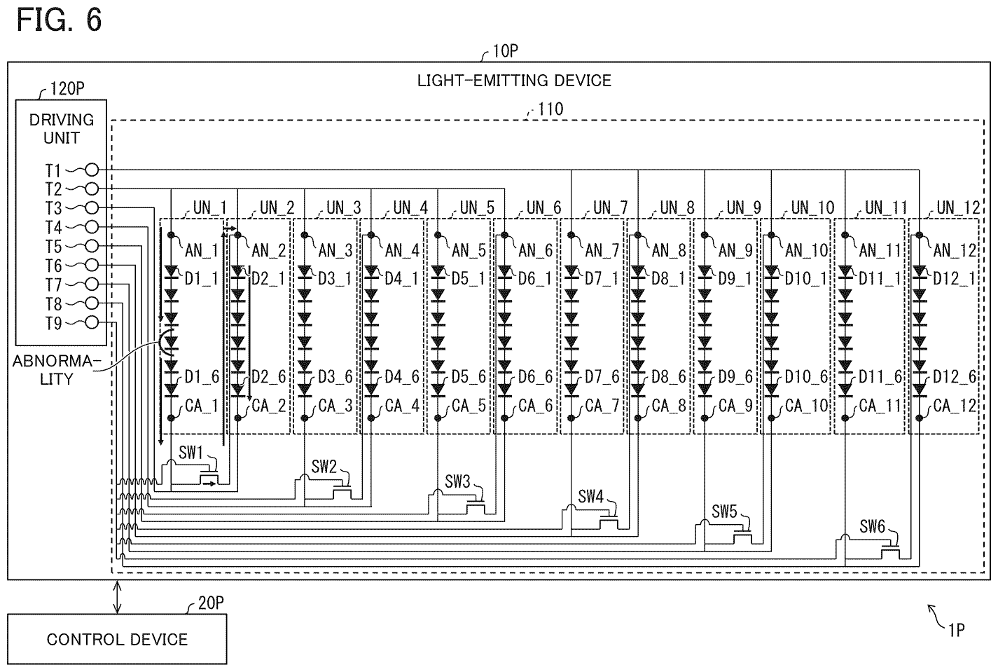

FIG. 6 is a diagram for explaining a first example of operation of the display apparatus 1P. In the following description, of the plurality of light-emitting units UN of the light-emitting device 10P, a given light-emitting unit is referred to as a “first light-emitting unit”. Moreover, a light-emitting unit corresponding to the first light-emitting unit is referred to as a “second light-emitting unit”. FIG. 6 illustrates a case where the light-emitting unit UN_1 serves as the first light-emitting unit and is the light-emitting unit UN_2 serves as the second light-emitting unit.

The anode side node of the first light-emitting unit is herein referred to as a “first anode side node”, and the cathode side node of the first light-emitting unit is herein referred to as a “first cathode side node”. In the example shown in FIG. 6, the anode side node AN_1 serves as the first anode side node, and the cathode side node CA_1 serves as the first cathode side node.

Further, the anode side node of the second light-emitting unit is herein referred to as a “second anode side node”, and the cathode side node of the second light-emitting unit is herein referred to as a “second cathode side node”. In the example shown in FIG. 6, the anode side node AN_2 serves as the second anode side node, and the cathode side node CA_2 serves as the second cathode side node.

In the example of Embodiment 1, it is assumed that an identical anode signal is supplied from the driving unit 120P to the first light-emitting unit and the second light-emitting unit. Accordingly, in the example of Embodiment 1, the first anode side node is connected to the second anode side node. In the light-emitting device 10P, the anode side node AN_1 is connected to the anode side node AN_2. Accordingly, an identical anode signal A1 is supplied to the anode side node AN_1 and the anode side node AN_2 through the signal terminal T2.

In the example of Embodiment 1, it is assumed that an identical cathode signal is supplied from the driving unit 120P to the first light-emitting unit and the second light-emitting unit. Accordingly, in the example of Embodiment 1, the first cathode side node is connected to the second cathode side node. In the light-emitting device 10P, the cathode side node CA_1 is connected to the cathode side node CA_2.

Accordingly, an identical cathode signal K1 is supplied to the cathode side node CA_1 and the cathode side node CA_2 through the signal terminal T3.

In addition, in the example of Embodiment 1, it is assumed that a switch is provided so that a state of connection between the first cathode side node and the second anode side node can be changed by the switch. Accordingly, in the example of Embodiment 1, it is assumed that the switch is located between the first cathode side node and the second anode side node.

In the light-emitting device 10P, the switch SW1 is located between the cathode side node CA_1 and the anode side node AN_2. Accordingly, as mentioned above, the control device 20P connects the cathode side node CA_1 and the anode side node AN_2 to each other by causing the light-emitting device 10P to turn on the switch SW1 in starting an inspection mode of the light-emitting device 10P.

In the inspection mode in the example shown in FIG. 6, (i) the anode signal A1 is supplied to the anode side node AN_1 and the anode side node AN_2, and (ii) the cathode signal K1 is supplied to the cathode side node CA_1 and the cathode side node CA_2. Moreover, as mentioned above, the switch SW1 is in an on state.

As a result of that, in the example shown in FIG. 6, an inspection current flows along a path “anode side node AN_1→cathode side node CA_1→switch SW1→anode side node AN_2→cathode side node CA_2”. Thus, in the example shown in FIG. 6, the inspection current flows from the light-emitting unit UN_1 to the light-emitting unit UN_2 via the switch SW1.

In the example shown in FIG. 6, the control device 20P determines, on the basis of the inspection current, whether there is an abnormality in each of the light-emitting units UN_1 and UN_2.

As noted above, unlike the light-emitting device 10A in FIG. 3 of Reference Embodiment, the light-emitting device 10P is provided with the switch SW1 located between the light-emitting unit UN_1 and the light-emitting unit UN_2. As a result of that, in the example shown in FIG. 6, whether there is an abnormality in either the light-emitting unit UN_1 or the light-emitting unit UN_2 can be determined unlike in the example shown in FIG. 3. This makes it possible to, in a case where there is an abnormality in one light-emitting element in the light-emitting unit UN_1 as shown, for example, in FIG. 6, determine that there is an abnormality in the light-emitting unit UN_1 alone.

As mentioned above, the control device 20P electrically isolates the cathode side node CA_1 and the anode side node AN_2 from each other by causing the light-emitting device 10P to turn off the switch SW1 in ending the inspection mode of the light-emitting device 10P.

As noted above, the display apparatus 1P (particularly the configuration of the light-emitting device 10P) newly created by the inventor of the present application makes it possible to detect an abnormality in the light-emitting device 10P with a method that is different from a conventional method.

### Second Example of Operation of Display Apparatus 1P

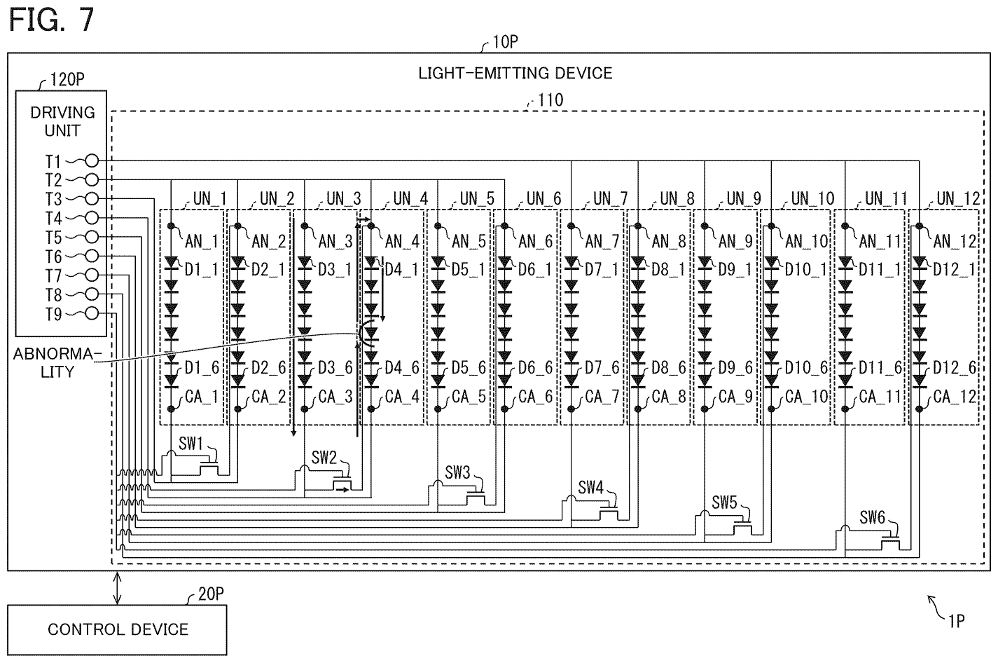

FIG. 7 is a diagram for explaining a second example of operation of the display apparatus 1P. Unlike the example shown in FIG. 6, FIG. 7 illustrates a case where the light-emitting unit UN_3 serves as the first light-emitting unit and the light-emitting unit UN_4 serves as the second light-emitting unit.

In the example shown in FIG. 7, the anode side node AN_3 serves as the first anode side node, and the cathode side node CA_3 serves as the first cathode side node. Moreover, the anode side node AN_4 serves as the second anode side node, and the cathode side node CA_4 serves as the second cathode side node.

In the light-emitting device 10P, the anode side node AN_3 is connected to the anode side node AN_4. Accordingly, an identical anode signal A1 is supplied to the anode side node AN_3 and the anode side node AN_4 through the signal terminal T2. Meanwhile, in the light-emitting device 10P, the cathode side node CA_3 is connected to the cathode side node CA_4. Accordingly, an identical cathode signal K2 is supplied to the cathode side node CA_3 and the cathode side node CA_4 through the signal terminal T4.

In the light-emitting device 10P, the switch SW2 is located between the cathode side node CA_3 and the anode side node AN 4. Accordingly, as mentioned above, the control device 20P connects the cathode side node CA_3 and the anode side node AN_4 to each other by causing the light-emitting device 10P to turn on the switch SW2 in starting an inspection mode of the light-emitting device 10P.

In the inspection mode in the example shown in FIG. 7, (i) the anode signal A1 is supplied to the anode side node AN_3 and the anode side node AN_4, and (ii) the cathode signal K2 is supplied to the cathode side node CA_3 and the cathode side node CA_4. Moreover, as mentioned above, the switch SW2 is in an on state.

As a result of that, in the example shown in FIG. 7, an inspection current flows along a path “anode side node AN_3→cathode side node CA_3→switch SW2→anode side node AN_4→cathode side node CA_4”. Thus, in the example shown in FIG. 7, the inspection current flows from the light-emitting unit UN_3 to the light-emitting unit UN_4 via the switch SW2.

In the example shown in FIG. 7, the control device 20P determines, on the basis of the inspection current, whether there is an abnormality in each of the light-emitting units UN_3 and UN_4. This makes it possible to, in a case where there is an abnormality in one light-emitting element in the light-emitting unit UN_4 as shown, for example, in FIG. 7, determine that there is an abnormality in the light-emitting unit UN_4 alone.

As mentioned above, the control device 20P electrically isolates the cathode side node CA_3 and the anode side node AN_4 from each other by causing the light-emitting device 10P to turn off the switch SW2 in ending the inspection mode of the light-emitting device 10P.

### Examples of Implementation by Software

The functions of the display apparatuses 1 to 1P (hereinafter called “apparatuses”) can be implemented by a program for causing a computer to function as the apparatuses and for causing a computer to function as control blocks (particularly the control devices 20 to 20P) of the apparatuses.

In this case, the apparatuses each include, as hardware for executing the program, a computer having at least one control device (e.g. a processor) and at least one storage device (e.g. a memory). Each of the functions described in the foregoing embodiments is implemented by executing the program with the control device and the storage device.

The program may be non-transiently stored on one or more computer-readable storage media. These storage media may or may not be included by the apparatuses. In the latter case, the program may be supplied to the apparatuses via a given wired or wireless transmission medium.

Some or all of the functions of the control blocks can also be implemented by a logical circuit. For example, an integrated circuit formed with a logical circuit functioning as the control blocks is also included in the scope of an aspect of the present disclosure. In addition to these, the functions of the control blocks can also be implemented, for example, by a quantum computer.

Each of the processes described in the foregoing embodiments may be executed by AI (artificial intelligence). In this case, A1 may operate on the control device or may operate on another device (such as an edge computer or a cloud server).

### Conclusion

According to Aspect 1 of the present disclosure, there is provided a light-emitting device including a plurality of light-emitting units each constituted by a plurality of light-emitting elements connected in series and in a forward direction. The plurality of light-emitting units include a first light-emitting unit and a second light-emitting unit corresponding to the first light-emitting unit.

A first anode side node serving as an anode side node of the first light-emitting unit is connected to a second anode side node serving as an anode side node of the second light-emitting unit. A first cathode side node serving as a cathode side node of the first light-emitting unit is connected to a second cathode side node serving as a cathode side node of the second light-emitting unit. The light-emitting device further includes a switch located between the first cathode side node and the second anode side node.

A display apparatus according to Aspect 2 of the present disclosure may include the light-emitting device according to Aspect 1 and a control device that controls the light-emitting device.

A display apparatus according to Aspect 3 may be directed to Aspect 2, wherein the control device may connect the first cathode side node and the second anode side node to each other by causing the light-emitting device to turn on the switch in starting an inspection mode of inspecting the light-emitting device for an abnormality in the first light-emitting unit and the second light-emitting unit.

A display apparatus according to Aspect 4 of the present disclosure may be directed to Aspect 3, wherein the control device may electrically isolate the first cathode side node and the second anode side node from each other by causing the light-emitting device to turn off the switch in ending the inspection mode.

A display apparatus according to Aspect 5 of the present disclosure may be directed to any one of Aspects 2 to 4, wherein the light-emitting device may be a backlight of the display apparatus.

According to Aspect 6 of the present disclosure, there is provide a method for inspecting a light-emitting device. The light-emitting device includes a plurality of light-emitting units each constituted by a plurality of light-emitting elements connected in series and in a forward direction. The plurality of light-emitting units include a first light-emitting unit and a second light-emitting unit corresponding to the first light-emitting unit. A first anode side node serving as an anode side node of the first light-emitting unit is connected to a second anode side node serving as an anode side node of the second light-emitting unit. A first cathode side node serving as a cathode side node of the first light-emitting unit is connected to a second cathode side node serving as a cathode side node of the second light-emitting unit. The light-emitting device further includes a switch located between the first cathode side node and the second anode side node. The method includes connecting the first cathode side node and the second anode side node to each other by turn on the switch in starting an inspection mode of inspecting the light-emitting device for an abnormality in the first light-emitting unit and the second light-emitting unit. Rider

An aspect of the present disclosure is not limited to any of the foregoing embodiments, but may be altered variously within the scope of the claims. An embodiment based on a proper combination of technical means disclosed in different embodiments is encompassed in the technical scope of an aspect of the present disclosure. Furthermore, a new technical feature can be formed by combining technical means disclosed in embodiments.

The present disclosure contains subject matter related to that disclosed in Japanese Priority Patent Application JP 2024-063369 filed in the Japan Patent Office on Apr. 10, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A light-emitting device comprising a plurality of light-emitting units each constituted by a plurality of light-emitting elements connected in series and in a forward direction,
the plurality of light-emitting units including a first light-emitting unit and a second light-emitting unit corresponding to the first light-emitting unit,
a first anode side node serving as an anode side node of the first light-emitting unit being connected to a second anode side node serving as an anode side node of the second light-emitting unit,
a first cathode side node serving as a cathode side node of the first light-emitting unit being connected to a second cathode side node serving as a cathode side node of the second light-emitting unit,
the light-emitting device further comprising a switch located between the first cathode side node and the second anode side node.

2. A display apparatus comprising:
the light-emitting device according to claim 1; and
a control device that controls the light-emitting device.

3. The display apparatus according to claim 2, wherein the control device connects the first cathode side node and the second anode side node to each other by causing the light-emitting device to turn on the switch in starting an inspection mode of inspecting the light-emitting device for an abnormality in the first light-emitting unit and the second light-emitting unit.

4. The display apparatus according to claim 3, wherein the control device electrically isolates the first cathode side node and the second anode side node from each other by causing the light-emitting device to turn off the switch in ending the inspection mode.

5. The display apparatus according to claim 2, wherein the light-emitting device is a backlight of the display apparatus.

6. A method for inspecting a light-emitting device, the light-emitting device including a plurality of light-emitting units each constituted by a plurality of light-emitting elements connected in series and in a forward direction,
the plurality of light-emitting units including a first light-emitting unit and a second light-emitting unit corresponding to the first light-emitting unit,
a first anode side node serving as an anode side node of the first light-emitting unit being connected to a second anode side node serving as an anode side node of the second light-emitting unit,
a first cathode side node serving as a cathode side node of the first light-emitting unit being connected to a second cathode side node serving as a cathode side node of the second light-emitting unit,
the light-emitting device further comprising a switch located between the first cathode side node and the second anode side node,
the method comprising connecting the first cathode side node and the second anode side node to each other by turn on the switch in starting an inspection mode of inspecting the light-emitting device for an abnormality in the first light-emitting unit and the second light-emitting unit.
